(19) United States
(12) Patent Application Publication
(10) Pub. No.: US 2003/0084095 A1
(43) Pub. Date: May 1, 2003

(54) Method to preserve web page links using registration and notification

(76) Inventor: Douglas Todd Hayden, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/035,359

(22) Filed: Oct. 26, 2001

(51) Int. Cl. G06F 15/16

(52) U.S. Cl. 709/203; 709/206

(57) ABSTRACT

A system and method for maintaining the integrity of hyperlinks for intranet and Internet applications through a registration and notification process. Hyperlink data is registered and stored in a user database for notifying the host of the hyperlink of any changes to data files associated with the hyperlink in order to help facilitate the preservation of the hyperlink.

### FIELD OF THE INVENTION

The present invention relates to hyperlinks and the maintenance of communications between web browsers or computing devices. More particularly, the present invention relates to the preservation, maintenance, and updating of hyperlinks across multiple platforms using a registration and notification process.

### BACKGROUND OF THE INVENTION

The Internet has become a tool used by many people throughout our society. The expansion of the Internet, along with an increased computing ability among the populace, has led to a proliferation of information being made available over the Internet. New web pages or Internet sites are consistently being developed and integrated into the world-wide-web. Similarly, old Internet sites are deleted, removed, renamed or transferred to new hosts. Such additions and deletions make it difficult to keep abreast of many of the changes occuring in cyberspace.

Regardless of the name used—Internet, cyberspace, world-wide-web—the core concepts behind the Internet are, for the most part, standardized. Computer software platforms, typically web browsers, connect personal computers, networks, hardware, personal data assistants, cell phones, pagers, and other computing devices with the communications structure that is the world-wide-web. While some computing devices are used to surf the web in search of information, trivia, or otherwise, other computing devices host information, or web pages. Similarly, intranets may be used to store, display, and provide access to information in the same manner as the Internet.

The Internet is essentially a series of linked data sources, otherwise known as web pages. Using web browser software, users may seamlessly browse between Internet sites stored on separate servers. Links between servers and web pages are identified by uniform resource locater (URL) addresses and static file names. Although the URL addresses are standardized and monitored, the individual static file names representing web pages and web page data are not regulated. Instead, naming conventions for the static files are left up to the webmaster or programmer developing the web pages for a specific URL address. This provides independent control of web pages to each entity maintaining a web page at a specific URL address.

To navigate the Internet, and the web of static files, individuals typically employ one of two methods. First, a user may navigate directly to a desired web page by specifying the URL address for that web page. In addition, a user may also specify a static file directory path and file name to retrieve. Typically, a web browser, the software used to surf the Internet, allows the user to designate a specific URL address to navigate to. For example, a user may enter the URL address “www.urlname.com” in the proper location of a web browser. Using the character identification of the URL address, the web browser contacts a database that stores the numerical URL address associated with the character address entered by the user. Once the numerical address is identified, the web browser attempts to contact the server hosting the URL address and to load the data contained at the identified URL address. If contact is made, the web browser displays the information stored at the URL address. Alternatively, the user may select a URL address from a saved list of frequently visited URL addresses. Once the URL address is designated, the web browser retrieves the data or information stored at the URL address and displays it for the user. This data may include links that provide a second method for navigating the Internet.

Navigation may also occur by linking. A link, or hyperlink, includes coded, or programmed, information that typically provides a web browser with a URL address and the location of a static file or files associated with the hyperlink. The static file may be resident on the server hosting the current static file displayed in a web browser, or it may be located at a remote site associated with an alternative URL address. Selection of a hyperlink displayed in a web browser triggers the web browser to jump to, or link to, the URL address and/or static file identified in the hyperlink. The use of hyperlinks and their operation is well known, and further explanation thereof is omitted for the sake of brevity.

One of the problems commonly associated with the Internet is the lack of standardization for maintaining links. Although the URL addresses are generally regulated and maintained, the naming and storing of static files that may be accessed at various URL addresses is the responsibility of the webmaster, or programmer, maintaining the web site. As web sites are updated, altered, and improved, many of the static file names are changed or deleted and old links to those static files are not maintained, resulting in broken links. Thus, if a web page includes a link to a deleted static file, the link is broken and a web browser attempting to access that static file will receive an error. For example, a company hosts a web site that includes product data stored in a static file entitled “products.html.” An external web page, not controlled or maintained by the company, includes a hyperlink to the company's product data stored at “products.html.” The company decides to split the product data into two units, due to an expanding product line, and changes the product data into two product data files, “productsA.html” and “productsB.html.” The old product data file “products.html” is deleted from the company's system. However, the hyperlink located on the external web page is not updated because the company does not know about the existence of the hyperlink, and the company does not control the web site hosting the hyperlink. Thus, a user selecting the hyperlink associated with the static file “products.html” on the external web page receives an error because a connection to the static file “products.html” cannot be made.

Broken links like those previously described have become more prevalent as the Internet expands. Therefore, it would be desirable to implement a system and method that would help unrelated web sites maintain the integrity of hyperlinks hosted or displayed by the respective web sites.

### SUMMARY OF THE INVENTION

The present invention relates to hyperlinks and the maintenance of communications between web browsers or computing devices. More particularly, the present invention relates to the preservation, maintenance, and updating of hyperlinks across multiple platforms using a registration and notification process.

Commonly, links between data files, or web pages, stored on servers, and accessed over the Internet or on an intranet, are disrupted due to changing characteristics of the data files. Particularly, alterations in the storage location or file names of data files and web pages cause numerous disruptions with web surfing. To alleviate some of the disruptions caused by such changing characteristics, the registration and notification system of the present invention provides a method and system for preserving the integrity of links used with an intranet or the Internet.

In one embodiment of the present invention, a remote server, hosting a data file with a link to a target data file hosted by a host server, registers the link with the host server. The remote server transmits information about the link, such as the file name and directory path of the data file being linked to, the contact address of the remote server, and any other pertinent information, to the host server. Alternatively, link registration may be accomplished by filling out an on-line form hosted by the host server. The host server stores this information in a user database. If the data file is altered in a manner that would disrupt links to that file, such as by a renaming of the data file or a change in the storage location of the data file, the host server notifies all remote servers having registered links associated with the altered data file stored in the user database. Typically, the remote servers may be informed by e-mail that the data file to which they maintain a link is being changed. The remote server may also be provided with information for correcting the outdated link, by, for example, being provided with a new path and file name for the linked data file. In this manner, the integrity of links to data files on a host server operating the registration and notification system may be preserved.

In an alternate embodiment of the present invention, the host server informs a remote server of the registration and notification system. Upon receiving a request for access to a data file stored on the host server by a remote server link, the host server e-mails the remote server with information about the registration and notification system operated by the host server. If the operator of the remote server then wishes to register with the registration and notification system of the host server, they may.

In still another embodiment of the present invention, a host server operating the registration and notification system of the present invention automatically registers links from remote servers and provides notification of any changes that might affect such links. When a remote server requests access to a data file, the host server determines if the requesting remote server has previously been identified as a linking server for that particular data file. This determination is made by querying a user database storing information about the existing links to the data files hosted by the host server. If the link by the remote server is registered in the user database, no further action is required. If the link is not registered in the user database, the registration and notification system of the present invention saves pertinent information about the remote server in the user database, including the data file being linked to and the URL address of the remote server. When a data file hosted by the host server is altered in a manner that may disrupt a link to the data file, the host server queries the user database for any links associated with that data file. For each link found, the registration and notification system notifies the webmaster at the URL address of the linking remote server of the change to the data file so that the webmaster may change any links associated with the data file that are hosted by the remote server. In this manner, links to data files hosted by the host server may be maintained.

The registration and notification system of the present invention serves to preserve and maintain the integrity of links between data files over the Internet or an intranet.

### DESCRIPTION OF THE DRAWINGS

While the specification concludes with claims particularly pointing out and distinctly claiming that which is regarded as the present invention, the present invention can be more readily ascertained from the following description of the invention when read in conjunction with the accompanying drawings in which:

FIG. 1 illustrates a block diagram of two computer systems for communicating with each other via the Internet;

FIG. 2 illustrates a block diagram of a web browser viewing a hyperlink associated with a network computer system over the Internet and the associated data file on a server computer system related to the hyperlink;

FIG. 3 illustrates a block diagram of a broken link between the computer systems and web browser illustrated in FIG. 2;

FIG. 4 illustrates a block diagram of multiple web browsers and multi-computer systems communicating via an Internet or intranet connection ; and

FIG. 5 illustrates a block diagram of a server computer system notifying a remote computer system and a network computer system of changes to hyperlinks associated therewith.

### DETAILED DESCRIPTION OF THE INVENTION

The present invention relates to hyperlinks and the maintenance of communications between web browsers or computing devices. More particularly, the present invention relates to the preservation, maintenance, and updating of hyperlinks across multiple platforms using a registration and notification process.

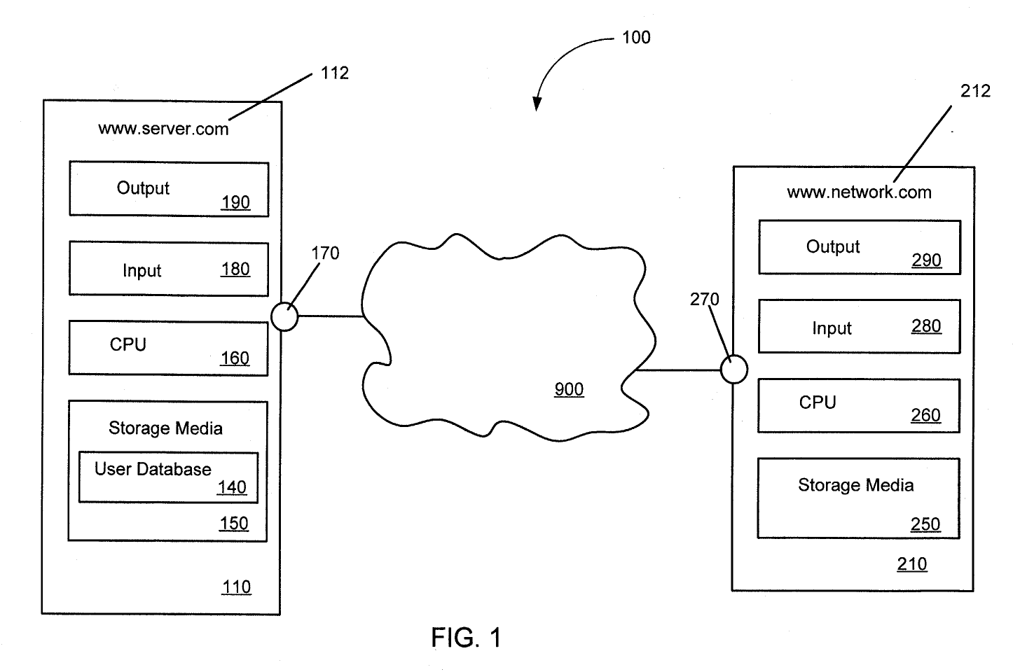

Illustrated in FIG. 1 is an Internet 900 communication link 100 between a host server 110 and a network server 210. A host server 110 may include one or more of each of the following: storage media 150, central processing units (CPU) 160, communication ports 170, input devices 180, and output devices 190. Storage media 150 may include such things as chip memory, flash memory, hard disks, floppy disks, optical disks, or other storage devices commonly associated with data storage of computing systems. One or more CPUs 160 perform the computational and management tasks generally associated with computing systems. Communication ports 170 may connect to an intranet, the Internet 900, or other computing devices as known in the art. Similarly, input devices 180 and output devices 190 may include any of a variety commonly associated with computers or known in the art of computer server systems.

Similarly, network system 210 may also include one or more of the following: storage media 250, CPUs 260, communication ports 270, input devices 280, and output devices 290. Such systems are known in the art. Network system 210 may also be associated with a URL address 212. For instance, the URL address for network server 210 is “www.network.com.”

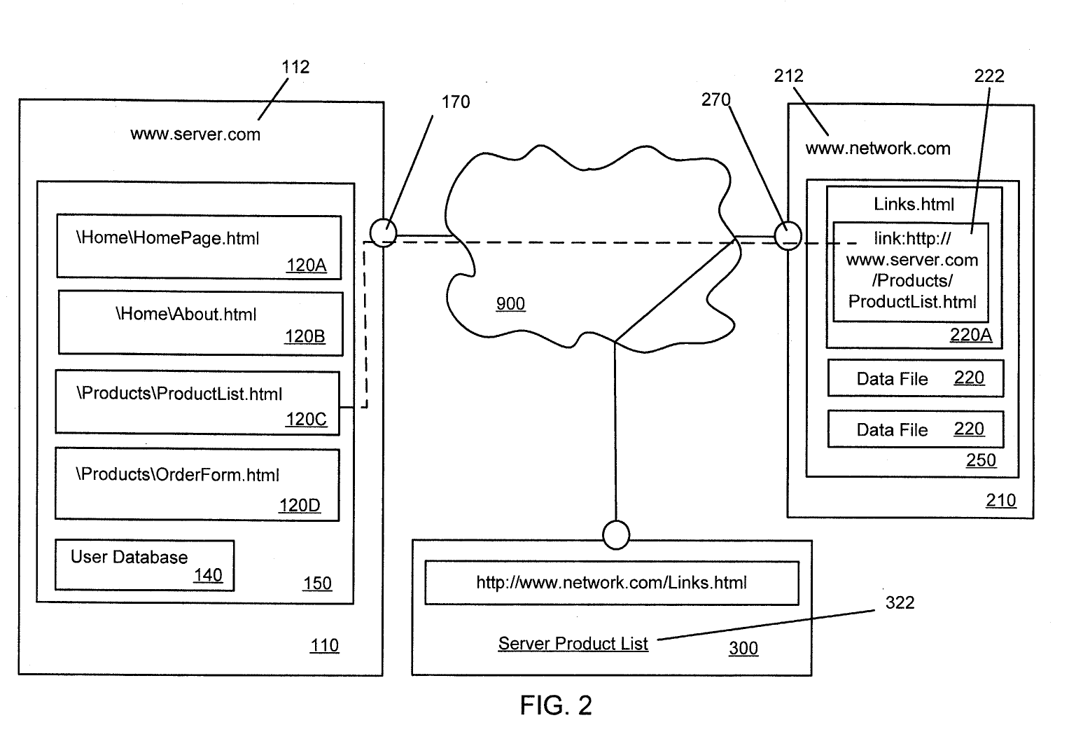

Host server 110 may also be associated with one or more URL addresses 112. As illustrated, a single URL address 112, “www.server.com,” is associated with host server 110. The URL address 112, in turn, is associated with one or more data files 120A-120D, stored on, or within, storage media 150 as illustrated in FIG. 2. Data files 120 may be a markup language file, such as HTML, text files, graphics files, or any other information carrying content file as known in the art. Each data file 120 is identified by a unique file name. A directory identifier may also be included to identify a data file 120 if the data file 120 is stored in a specific directory of the storage media 150. For example, data file 120A is identified by the file name “HomePage.html” and is located in the directory “\Home\.” Likewise, data file 120C is identified by the file name “ProductList.html” and is located in a “\Products\” directory of storage media 150. File naming conventions, such as those illustrated, are well known and it is understood that alternative naming conventions could also be used with the present invention as known in the art.

Network server 210 may also store one or more data files 220 in storage media 250. For instance, a data file 220A identified by the file name “Links.html” is stored in storage media 250. Data file 220A includes a link 222 associated with data file 120C on the host server 110. The link 222 association with data file 120C is identified by the link information “http://www.server.com/Products/ProductList.html.” A broken line illustrates the connection between link 222 and data file 120C in FIG. 2, although it is understood that the link only occurs if a user browsing data file 220A selects link 222.

A web browser 300 accessing data file 220A at the URL address 212, “www.network.com,” displays the data contained in data file 220A. Web browser 300 displays link 222 as identifying text 322, for example “Server Product List.” The identifying text 322 is included in the code of data file 220A as known in the art. If a user selects or activates the identifying text 322, the web browser attempts to retrieve the data or information from the site identified by the link information of link 222. For example, web browser 300 displays identifying text 322 associated with link 222. A user selecting identifying text 322, such as by clicking on the identifying text 322 with a mouse, triggers the execution of the codes associated with link 222. In the instant case, the web browser 300 is directed to connect to a data file 120C located at “http://www.server.com/Products/ProductList.html.” Acting on this command, web browser 300 attempts to connect to host server 110 through Internet 900 because host server 110 is associated with the URL address “www.server.com.” In doing so, web browser 300 specifically attempts to connect to the data file 120 associated with the directory path and file name “/Products/ProductList.html,” in this case, data file 120C. Once a connection is made, web browser 300 displays the information or data stored in data file 120C (not shown).

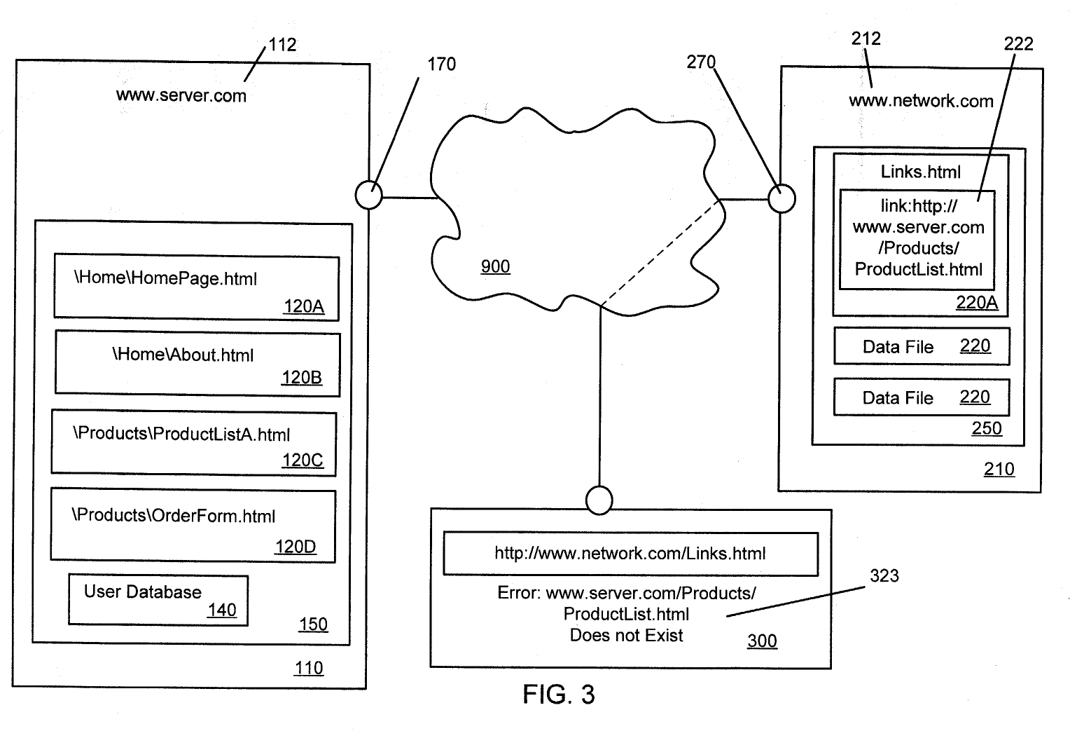

However, if data file 120C is renamed or stored in a different directory, link 222 becomes outdated and web browser 300 is unable to connect with the intended data file 120C upon the selection of identifying text 322. This causes an error that is displayed by the web browser 300 because the web browser 300 is unable to locate the desired data file 120C given the outdated link information provided by link 222. Such errors are common with Internet 900 usage because of the changing characteristics, information and storage locations of data files. For example, FIG. 3 illustrates the instance where the name of data file 120C has been changed to “ProductListA.html.” Selection of identifying text 322 prompts the web browser 300 to search for the data file 120 associated with link 222. The data file 120 associated with file name “ProductList.html” no longer exists, however. Thus, web browser 300 is unable to locate the nonexistent data file 120 and displays an error 323 to the user. Such error messages are common in the art and further explanation thereof is omitted.

The independence of host server 110 from network server 210 illustrates the problems associated with link changing and the Internet 900. Once a data file is renamed, or moved to a different URL address, it becomes difficult to preserve the integrity of links 222 not associated with, or controlled by, the party controlling a host server 110.

The registration and notification system of the present invention helps to solve this problem, or at least decrease the number of broken links experienced with the Internet. In one embodiment of the present invention, a registration and notification system provides a method by which links stored on associated or unassociated servers, or at unassociated URL addresses, may be maintained and updated. A network server 210 hosting a link 222 to a data file 120 on a host server 110 may register the link 222 with the host server 110 so that the host server 110 may notify the network server 210 of any changes in the link information associated with link 222. The registration and notification system of the present invention is typically a software program that performs the functions of the present invention as defined herein.

A host server 110 using the registration and notification system of the present invention may include one or more user databases 140 stored on storage media 150. A user database 140 may include information about remote links to data files 120. For instance, information about link 222 of data file 220 on network server 210 may be stored in a user database 140 on the host server 210. The information about link 222 may include such things as the URL address 212 of the network server 210 hosting link 222, the file name of the data file 220 linked by link 222, a maintenance e-mail address for notifying an administrator or controller of network server 210 of changes made to the linked data file 120, and the like. A user database 140 for each data file 120 hosted by host server 110 may be maintained, or databases capable of storing information about multiple data files 120 may be used, depending upon the number of links that exist for each data file 120.

A user database 140 may be compiled in any number of ways. In one embodiment of the present invention, the host server 110 may include a notification that a registration and notification system exists and that a remote server may register links with the host server 110 by e-mailing specific information to host server 110 at a specified e-mail address. The notification may appear as text included in each of the data files 120 or only in select data files, such as the “/Home/HomePage.html” data file 120A, such that a user viewing the data file 120 with a web browser would be informed of the existence of the registration and notification system. Typically, the e-mail address identified for communications may be a generic e-mail address such as “webmaster@URLaddress” where “URLaddress” is the address of the host server. For example, host server 110 may have a generic e-mail address “webmaster@server.com” for receiving e-mails about the data files 120 associated with the URL address 112 “www.server.com.” Generic e-mail addresses to a “webmaster” at a URL address are common. Alternatively, a specific e-mail address associated with the registration and notification system of host server 110 may be maintained to receive link information, such as “linkregistration@server.com.” Specific e-mail addresses for maintaining user databases 140 may be preferred if automatic processes, such as script programs and processing, are used to maintain and update user databases 140.

Using this embodiment of the present invention, a remote server, such as network server 210, registers link 222 with the host server 110 by sending e-mail with link information to the host server 110. Typically, all that is needed for the registration and notification system is an e-mail address of the network server 210 webmaster, or controller, and an identification of the data file 120 to which the link 222 pertains. For instance, the following e-mail is an example of an e-mail that may be sent by network server 210 to register a link 222 with a host server 110:

To: linkregistration@server.com

From: webmaster@network.com

Link: \Products\ProductList.html

Upon receiving the e-mail, the information may be manually, or automatically, transferred to a user database 140 accessible to host server 110. Manual transfer involves a user, such as a webmaster or controller, reading the e-mail and manually entering information into a user database 140. Automatic transfer of data to a user database 140, however, may be achieved using programming code associated with the e-mail system of the host server 110 that automatically strips information from any e-mail sent to the e-mail address “linkregistration@server.com” and stores it in a user database 140. For example, a script program could identify the origin e-mail address, “webmaster@network.com,” and the link information, “\Products\ProductList.html,” and store this information in a user database 140.

The registration and notification system of the present invention may use the user database 140 to update remote servers with link information if the information is altered on host server 110. For example, if data file 120C is renamed “ProductListA.html,” the registration and notification system prompts host server 110 to search the user databases 140 for any links associated with data file 120C. If the information from the previously described e-mail is stored in the user databases 140, the registration and notification system prompts the host server 110 to notify the remote server of the changes to the data file 120C information. In this case, host server 110 e-mails network server 210 a notification of a link change, such as the following:

To: webmaster@network.com

From: linkregistration@server.com

Link change: Old: \Products\ProductList.html

New: \Products\ProductListA.html

In this manner, network server 210 is informed of the link change so that the link 222 may be updated with the most current information. This helps to maintain the integrity of links over the Internet.

Once information from the user database 140 is used to inform a remote server of a link change, the information may be erased from the user database 140. Alternatively, the information may be retained, either permanently, or for some specified time period over which additional e-mail reminders of the link changes may be sent by host server 110.

In another embodiment of the present invention, information used to compile a user database 140 may be retrieved from an on-line form hosted by the host server 110. A user wishing to register a link with the registration and notification system may fill out an interactive web page or form capable of accepting data entry. The data may then be added to the user database 140.

In another embodiment of the present invention, the registration and notification system uses host server 110 to notify remote servers, such as network server 210, of the registration and notification system via e-mail. When a remote server links to host server 110, the URL address of the linking server is determined by host server 110. Host server 110 may query a user database 140 to determine if the remote server is registered with the registration and notification system of the present invention. If the URL address of the linking server is not found in the user database 140, host server 110 assumes that registration has not occurred. To notify the linking server of the link registration and notification process, host server 110 automatically sends an informative e-mail to “webmaster@URLaddress” where “URLaddress” is the URL address of the linking server as determined by host server 110. As previously discussed, the “webmaster” address is commonly used for maintenance of web based servers, thus, it is likely that the informative e-mail about the availability of the registration and notification system will reach an individual charged with maintaining the linking server. Optionally, host server 110 may maintain a second user database (not shown) to store a list of URL addresses that have been informed of the registration and notification system. Before sending an informative e-mail, host server 110 may check the second user database to ensure that the URL address of the linking server has not been previously informed of the registration and notification system. If an informative e-mail was previously transmitted, host server 110 may refrain from sending a duplicative e-mail.

In another embodiment of the present invention, the registration and notification system uses host server 110 to automatically create a user database 140 of each URL address that links to data files 120 stored on host server 110. If one of the data files 120 hosted by host server 110 is renamed or moved to a different storage location, each URL address that has linked to the changed data file 120 is notified of the change by e-mail. Typically, the e-mail is sent to a generic e-mail address such as “webmaster@URLaddress” where “URLaddress” is the address of the linking remote server, as previously discussed.

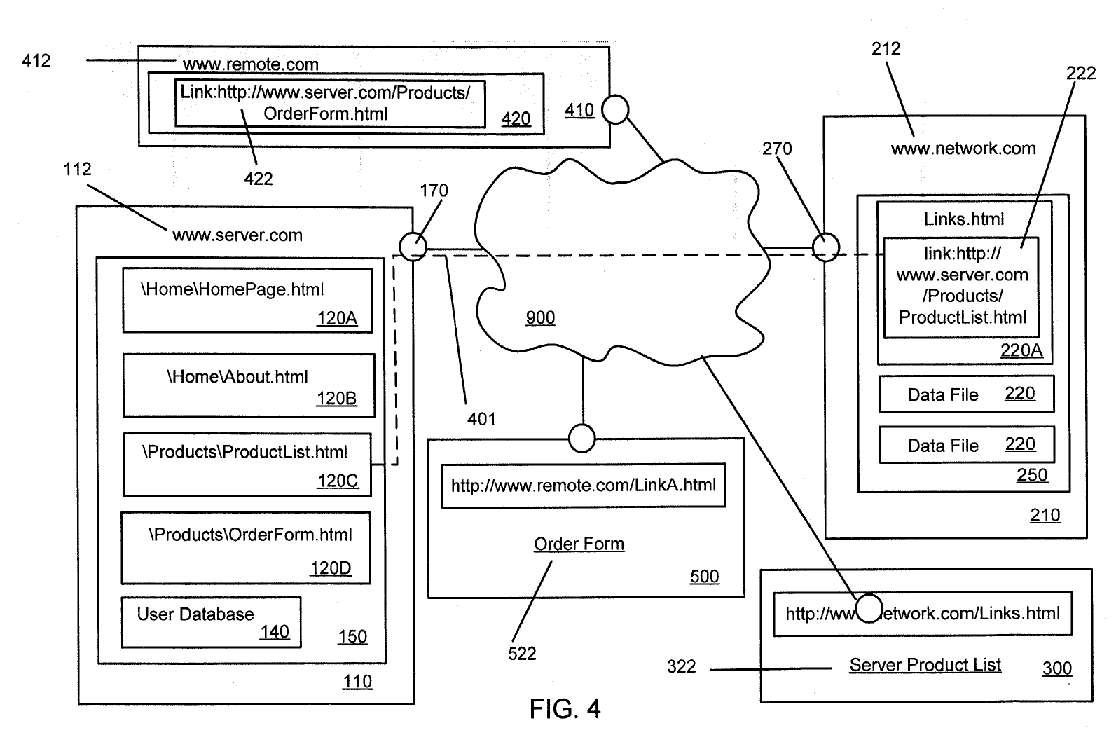

An example of this embodiment of the present invention is illustrated in FIG. 4. Host server 110 hosts data files 120, including data file 120C, with a directory path and filename “\Products\ProductList.html,” and data file 120D, with a directory path and filename “\Products\OrderForm.html.” Network server 210 includes data file 220 with link 222 associated with data file 120C of host server 110. A remote server 410 includes data file 420 with link 422 associated with data file 120D of host server 110. A user accessing web browser 300 to view data file 220 hosted by network server 210 is presented with identifying text 322 associated with link 222. Selecting identifying text 322, the user is routed to the data file 120C hosted by host server 110. This link is illustrated by broken line 401. Receiving a request for the information in data file 120C, the registration and notification system uses host server 110 to identify the URL address of the network server 210. The registration and notification system stores the URL address, along with any other desired information, in a user database 140, and associates the information with data file 120C.

Similarly, a user accessing web browser 500 to view data file 420 hosted by remote server 410 is presented with identifying text 522 associated with link 422. Selecting identifying text 522, the user is routed to the data file 120D hosted by host server 110 because identifying text 522 is associated with link 422 directed at “http://www.server.com/Products/OrderForm.html.” Receiving a request for the information in data file 120D, the registration and notification system uses host server 110 to identify the URL address of the remote server 410. The registration and notification system stores the URL address, along with any other desired information, in a user database 140, and associates that information with data file 120D.

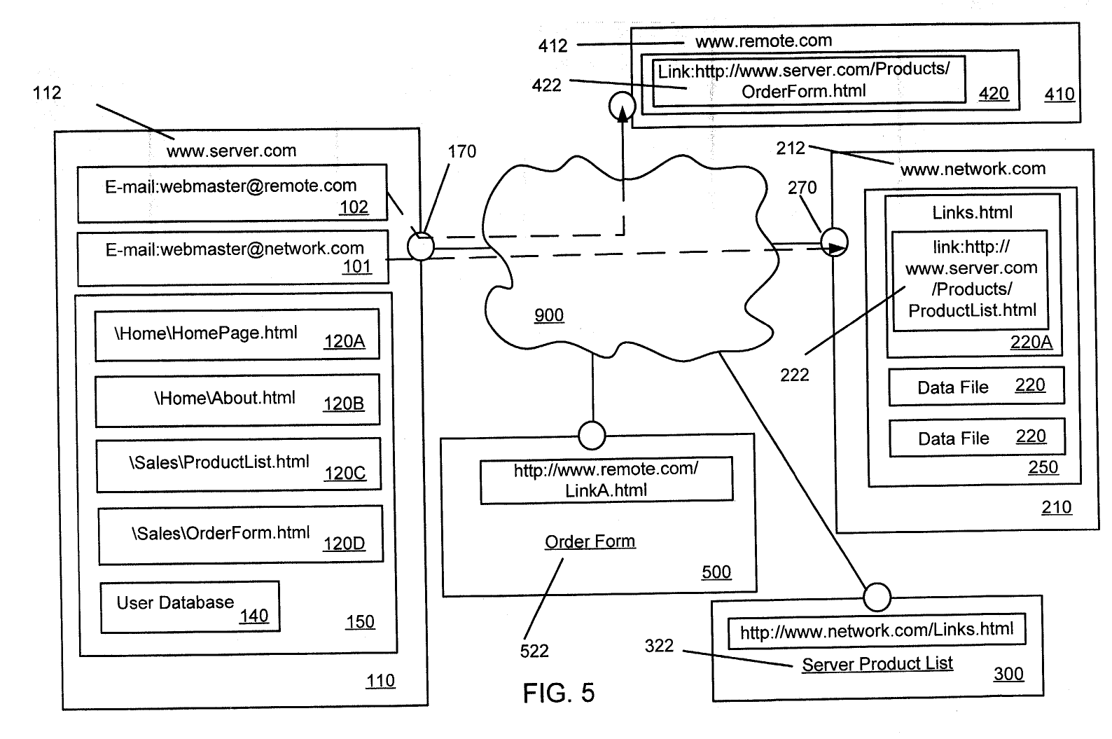

When data files 120C and 120D hosted by host server 110 are transferred to a different directory, the registration and notification system informs network server 210 and remote server 410 of the changes. For instance, if the directory path “\Products\” is changed to the directory “\Sales\” data files 120C and 120D are affected as illustrated in FIG. 5. The change in the status of the data files 120C and 120D prompts the registration and notification system to ascertain the identity of those servers which have linked to the changed data files 120C and 120D. Using host server 110, the registration and notification system queries user database 140 for any entries associated with data file 120C. Finding the URL address 212 “www.network.com,” the registration and notification system of the host server 110 transmits an e-mail 101 to “webmaster@network.com” informing the webmaster of the directory path change of data file 120C so that any links 222 associated with data file 120C may be updated on the network server 210.

Similarly, the registration and notification system of the present invention searches the user database 140 for any servers that have linked to data file 120D. Finding the URL address 412 “www.remote.com” associated with data file 120D in the user database 140, an e-mail 102 is sent to “webmaster@remote.com” informing the webmaster of the directory path change of data file 120D so that any links 422 associated with data file 120D may be updated on the remote server 410. In this manner, those servers hosting links associated with data files 120 hosted by host server 110 may be informed of any changes to data files 120, thereby helping to preserve the integrity of links used over the internet.

In still another embodiment of the present invention, a central computer system may host a user database for registering hyperlinks and notifying hyperlink hosts of changes to those hyperlinks. A host server would register its data files with the central computer. Any network servers or remote servers linking to the data files hosted by host server would register the links with the central computer. The user database maintained by the central computer may then be used to notify hyperlink hosts of changes to the data files associated with the hyperlinks. For instance, upon changing the path directory of a data file, a host server notifies the central computer of the change. Using the user database, the central computer determines those network and remote servers having hyperlinks to the changed data file. Based upon the information retrieved from the user database, the hyperlink hosts are notified of the changes in the data file path directory so that they may update the hyperlinks associated with the linked data file.

The registration and notification system of the present invention provides an efficient and user-friendly method and system for maintaining the integrity of links used over the Internet. Although the registration and notification system has been described with reference to the Internet, it is understood that the registration and notification system could also be used in the same manner with an intranet system.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method for preserving hyperlinks, comprising:
registering a hyperlink stored on a first computer with a second computer hosting a data file associated with said hyperlink; and
notifying said first computer of a change in said data file associated with said hyperlink.

2. The method of claim 1, wherein registering a hyperlink stored on a first computer comprises:
identifying said data file associated with said hyperlink; and
identifying an e-mail address for notifying via e-mail changes to said data file.

3. The method of claim 2, further comprising saving said data file identification in a user database.

4. The method of claim 2, further comprising saving said e-mail address identification in a user database.

5. The method of claim 2, further comprising:
saving said data file identification in a user database accessible to said second computer;
saving said e-mail address identification in a user database accessible to said second computer; and
creating a relationship between said saved data file identification and said saved e-mail address identification for facilitating said notifying of said first computer of a change in said data file.

6. The method of claim 1, wherein notifying said first computer of a change in said data file associated with said hyperlink comprises e-mailing a notification of said data file change to said first computer.

7. The method of claim 1, wherein notifying said first computer of a change in said data file associated with said hyperlink comprises notifying an individual in charge of maintaining said hyperlink of said change in said data file.

8. A method for preserving Internet or intranet communications, comprising:
storing a hyperlink for linking to at least one data file stored on a host computer;
registering said hyperlink with said host computer; and
notifying a party responsible for maintenance of said hyperlink of any changes in said at least one data file that affect the integrity of said hyperlink.

9. The method of claim 8, further comprising, storing a set of registration data in a user database.

10. The method of claim 9, wherein storing a set of registration data in a user database comprises storing a set of registration data in a user database accessible to said host computer.

11. The method of claim 9, wherein storing a set of registration data in a user database comprises storing a set of registration data selected from the group consisting of uniform resource locators, e-mail addresses, hyperlinks, and data file names.

12. The method of claim 8, wherein said storing a hyperlink comprises, storing a hyperlink on a first computer.

13. The method of claim 8, wherein registering said hyperlink with said host computer comprises initiating said registration by said host computer.

14. The method of claim 8, wherein registering said hyperlink with said host computer comprises:
retrieving a uniform resource locator associated with a computer storing said hyperlink;
identifying a file name of said at least one data file stored on said host computer associated with said hyperlink; and
storing said uniform resource locator and said identified file name in a user database.

15. The method of claim 8, wherein said notifying a party responsible for maintenance of said hyperlink of any changes in said at least one data file that affect the integrity of said hyperlink comprises e-mailing a notification to said party responsible for maintenance of said hyperlink.

16. A registration and notification system for preserving the integrity of hyperlinks, comprising:
a host server;
at least one data file accessible to said host server;
at least one remote server;
at least one hyperlink stored on said at least one remote server, said at least one hyperlink associated with said at least one data file; and
a user database stored on said host server for identifying said at least one hyperlink associated with said at least one data file.

17. The system of claim 16, wherein said host server comprises:
at least one central processing unit;
at least one input device;
at least one output device;
at least one communications port;
at least one storage media for storing data; and
a URL address associated with said host server.

18. The system of claim 17, wherein said user database stored on said host server is stored on said at least one storage media.

19. The system of claim 16, wherein said remote server comprises:
at least one central processing unit;
at least one input device;
at least one output device;
at least one communications port;
at least one storage media for storing data; and
a URL address associated with said host server.

20. The system of claim 16, wherein said user database stored on said host server comprises data selected from the group consisting of uniform resource locators, e-mail addresses, hyperlinks, and data file names.
